(19) United States
(12) Patent Application Publication
(10) Pub. No.: US 2011/0055015 A1
(43) Pub. Date: Mar. 3, 2011

(54) METHOD AND NETWORK NODE FOR DEFERRING A TRANSMISSION OF A MESSAGE COMPRISING AN ADVERTISEMENT COMPONENT

(75) Inventor: Edoardo Gavita, Laval (CA)

(73) Assignee: TELEFONAKTIEBOLAGET LM ERICSSON (PUBL), Stockholm (SE)

(21) Appl. No.: 12/550,725

(22) Filed: Aug. 31, 2009

(51) Int. Cl. G06Q 30/00

(52) U.S. Cl. 705/14.61; 705/14.64

(57) ABSTRACT

The invention relates to a method and network node for deferring a transmission of a message comprising an advertisement (Ad) component. The method comprises the steps of detecting that a target device for the message is roaming and that a deferring option is active for the target device. The method also comprises a step of storing the message with the Ad component. After the step of storing, the method comprises a step of receiving a notification indicating that the target device is not roaming. If the Ad component is valid, a step of sending the message to the target device is executed and if the Ad component is not valid, the steps of retrieving a new Ad, updating the message with the new Ad and sending the message to the target device are executed.

### TECHNICAL FIELD

The present invention relates to the field of messaging and more particularly to the transmission of a message comprising an advertisement component.

### BACKGROUND

Today, messaging is omnipresent. The quantity of Short Message Service (SMS), Multimedia Messaging Service (MMS), emails and other multimedia content exchanged between users of mobile user devices is very important and is still growing.

The availability of this multitude of messaging means opens the door to multimedia advertisement and content targeting. Advertisements (Ads) for displaying in a mobile device, for example, can be targeted as the identity and the location of a user device can be inferred. Further, the content of messages communicated through the mobile device offers a great source of information useful for targeted advertising.

It is therefore possible today to receive Ads that are targeted according to message content or to a user's profile or location, for example. However, while a mobile device is roaming, the costs of receiving these messages increase dramatically.

### SUMMARY

It is therefore a general object of this invention to provide a method and network node for overcoming at least some of the prior art drawbacks.

According to an aspect of the invention, a method, executed in a network node, for deferring a transmission of a message comprising an advertisement (Ad) component is provided. The method comprises the steps of detecting that a target device for the message is roaming and that a deferring option is active for the target device and storing the message with the Ad component. The method comprises, after the step of storing, receiving a notification indicating that the target device is not roaming and if the Ad component is valid, sending the message to the target device, else if the Ad component is not valid, retrieving a new Ad, updating the message with the new Ad and sending the message to the target device.

According to another aspect of the invention, a method executed in a network node, for deferring a transmission of a message comprising an advertisement (Ad) component is provided. The method comprises the steps of detecting that a first target device for the message is roaming and that a deferring option is active for the first target device and storing the message with the Ad component. The method comprises, after the step of storing, receiving a notification indicating that a second target device is not roaming, and if the Ad component is valid, sending the message to the second target device, else if the Ad component is not valid, retrieving a new Ad, updating the message with the new Ad and sending the message to the second target device.

According to another aspect of the invention, a network node for deferring a transmission of a message comprising an advertisement (Ad) component is provided. The network node comprises a first interface in communication with other network nodes, said first interface detecting if a target device for the message is roaming, detecting if a deferring option is active for the target device and receiving a notification indicating that the target device is not roaming. The network node further comprises a database for storing the message with the Ad component, when the first interface detects that the target device is roaming and that the deferring option is active for the target device. The network node further comprises a second interface in communication with an Ad server, for retrieving a new Ad and a processing module for verifying if the Ad component stored in the database is valid, for retrieving a new Ad using the second interface and for updating the message with the new Ad if the Ad component stored in the database is not valid, when a notification indicating that the target device is not roaming is received by the first interface. The network node further comprises a third interface, in communication with the target device, for sending the message with the Ad component to the target device.

According to another aspect of the invention, a network node for deferring a transmission of a message comprising an advertisement (Ad) component is provided. The network node comprises a first interface in communication with other network nodes, said first interface detecting if a first target device for the message is roaming, detecting if a deferring option is active for the first target device and receiving a notification indicating that a second target device is not roaming. The network node further comprises a database for storing the message with the Ad component, when the first interface detects that the first target device is roaming and that the deferring option is active for the first target device. The network node further comprises a second interface in communication with an Ad server, for retrieving a new Ad and a processing module for verifying if the Ad component stored in the database is valid, for retrieving a new Ad using the second interface and for updating the message with the new Ad if the Ad component stored in the database is not valid, when a notification indicating that the second target device is not roaming is received by the first interface. The network node further comprises a third interface, in communication with the second target device, for sending the message with the Ad component to the second target device.

### BRIEF DESCRIPTION OF THE DRAWINGS

The objects and advantages of the invention will be understood by reading the detailed description in conjunction with the figures, wherein:

FIG. 1 is a flowchart illustrating an exemplary method according to the invention;

FIG. 2 is a block diagram illustrating an exemplary network node according to the invention;

FIG. 3 is a block diagram illustrating nodes of a network, according to an exemplary embodiment of the invention; and

FIG. 4 is a block diagram illustrating nodes of a network, according to an exemplary embodiment of the invention.

### DETAILED DESCRIPTION

The various features of the invention will now be described with reference to the figures. These various aspects are described hereafter in greater detail in connection with exemplary embodiments and examples to facilitate an understanding of the invention, but should not be construed as limited to these embodiments. Rather, these embodiments are provided so that the disclosure will be thorough and complete, and will fully convey the scope of the invention to those skilled in the art.

The embodiments according to the present invention are described with reference to block diagrams and/or operational illustrations of methods, servers, and computer program products. It is to be understood that each block of the block diagrams and/or operational illustrations, and combinations of blocks in the block diagrams and/or operational illustrations, can be implemented by radio frequency, analog and/or digital hardware, and/or computer program instructions. Thus, the various aspects of the invention may be embodied in many different forms, and all such forms are contemplated to be within the scope of the invention. The computer program instructions may be provided to a processor circuit of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Furthermore, in some illustrations, some blocks may be optional and may or may not be executed.

When a user has subscribed to an advertisement (Ad) service, he usually receives a messages as originally sent by a sender, accompanied with an Ad component which has been inserted by the Ad service, after the message was sent. This happens regardless of whether the recipient is roaming or not. Generally, a user has no control of the content of the Ads received in terms of their sizes. Therefore, expensive costs from downloading large Ad messages, while roaming, may be incurred.

The present invention proposes an Ad service which may be set-up such that the user receives messages with their Ads components, sent while the user was roaming, at a later time when he is not roaming anymore.

The present invention therefore proposes to store the message with the original Ad in a database while a user is roaming. When the recipient is not roaming anymore, the message is retrieved from the database and sent to the user. However, before the message is sent, the validity of the Ad component is verified and, if necessary a new Ad is fetched and incorporated to the message, thus replacing the original Ad.

In order to do that, the message is first stored, with its AD component, when the recipient is roaming, unavailable or unwilling to take the message. Then, a verification of the Ad is made to determine if it is still valid, when the recipient comes online and is not roaming anymore. The verification consists of revisiting the integrity of the AD in terms of content and time criteria and also to select the appropriate AD in reference to the user device, in the case where the recipient has registered multiple user devices and uses a device different from the one to which the message was originally directed to, to receive the stored message.

The present invention proposes to re-use existing mobile notification mechanisms such as Home Location Register (HLR) Alert-SC, Location Based Service Spatial Triggers and SIP REGISTER Event packages, to notify a node of the network when the recipient has just entered the network i.e. the user is no longer roaming or unavailable. The present invention also introduces a new notification function to initiate a process to send out any deferred messages along with an “updated” AD component, if necessary. This new notification indicator indicates to a network node to fetch the message and also to fetch an updated Ad component to be sent with the message. For the user, this should be done in a transparent way.

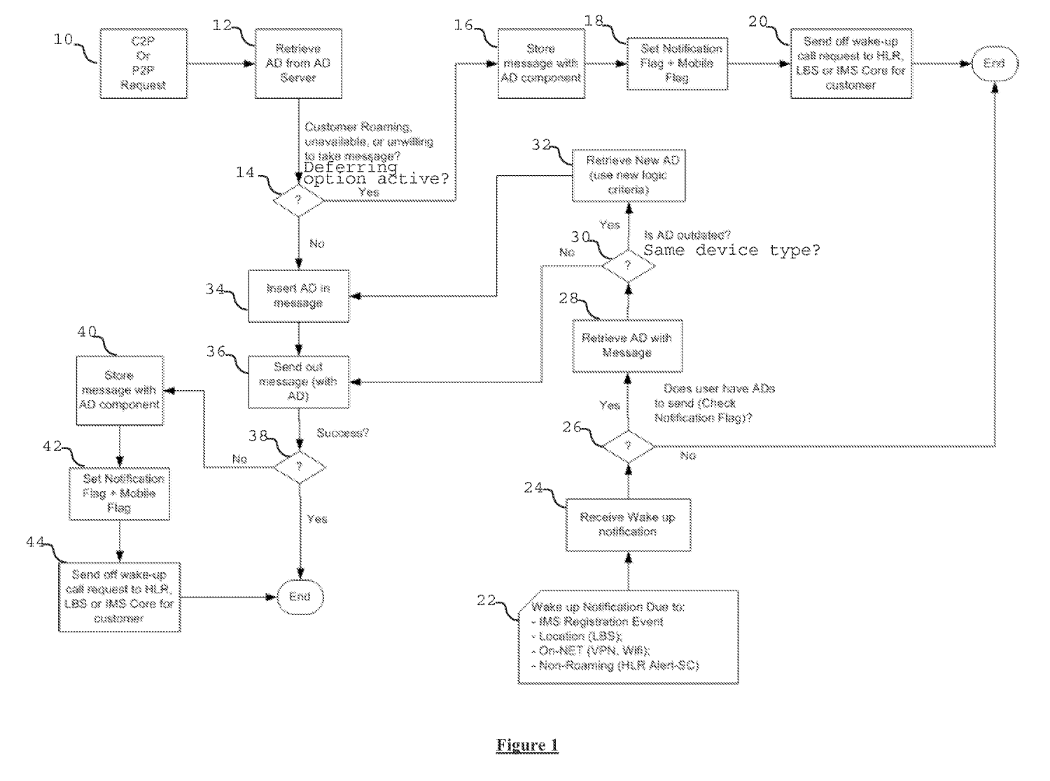

Reference is now being made to FIG. 1, where a method, executed in a network node, for deferring a transmission of a message comprising an advertisement (Ad) component is illustrated. The method starts with the reception of a content server (C2P) or peer-to-peer (P2P) request, step 10. The content of the request, which in many instances may contain a message, is then processed and a targeted Ad is retrieved from an Ad server, step 12. The step 14 of detecting that a target device for the message is roaming and that a deferring option is active for the target device is then executed. A deferring option is an option allowing a user to instruct a network node, for example, to keep a message in a database while the user is roaming or unavailable and to send it later when the user stops roaming or becomes available. If it is determined that the device is roaming and the deferring option is active, the step 16 of storing the message with the Ad component is executed. Optionally, the step 18 of setting a notification flag indicative that a message with an Ad is stored and the step of setting a flag indicating a device type of the first target device are executed. Optionally, the step 20 of sending a notification request to another network node for receiving a notification indicating that the target device is not roaming is executed.

After the step 16 of storing, the steps 22 and 24, of receiving a notification indicating that the target device is not roaming are executed. This notification may be generated, for example, when a user enters an area covered by the operator of the cellular network to which he subscribes, and where no roaming fees are charged. At step 26, optionally, it is verified if a message is stored and the message with its Ad component are retrieved at step 28. At step 30, it is verified if the Ad component is valid. If the Ad is invalid or outdated or if the device connected is not of the same type as the type identified by the flag indicating a device type, then step 32 of retrieving a new Ad is executed. Step 34 of updating the message with the new Ad is then executed. On the other hand, if the Ad is valid and a device has the same type as the flag indicating a device type, the step 36 of sending the message to the target device is executed.

Other optional steps 38 to 44 of verifying if the message transmission was a success and of taking corrective measures otherwise may also be executed.

In order to verify if an Ad is valid, various verifications may be executed. Among these, a verification of the validity period of the Ad, compared with the current date may be executed. Therefore, if the current date is outside the validity period of the original Ad component of the message, this Ad may be replaced with an Ad which is valid at the current date and time. Similarly, if the devices to which the original message was sent was a mobile device, for instance, and the device on which the message is retrieved is a fixed device, the Ad may be replaced by an Ad directed to users of fixed device instead of an Ad directed to users of mobile devices. One of ordinary skills in the art will readily understand that many different verifications may be made and all these verifications, such as of the location of the device, the history of message downloads on the device, etc. are meant to be included in the present invention.

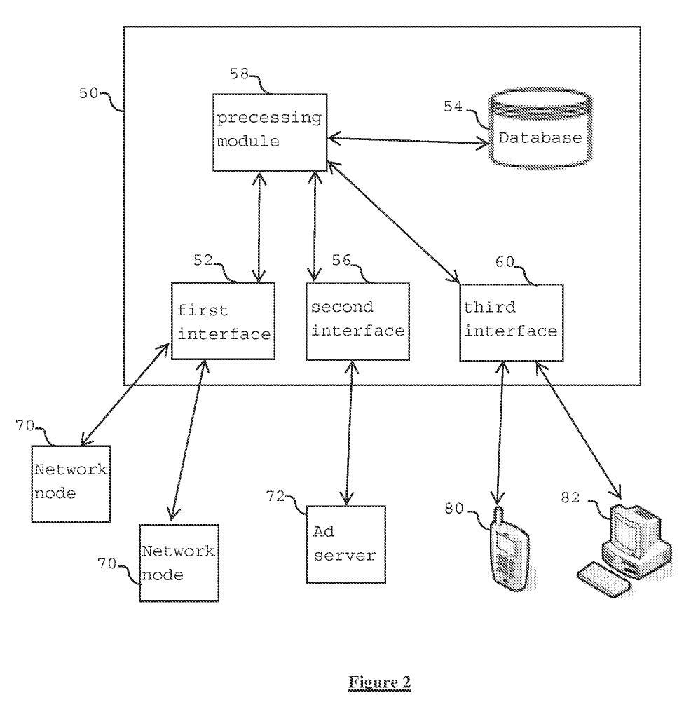

Reference is now being made to FIG. 2, where a network node 50 for deferring a transmission of a message comprising an Ad component is provided. The network node 50 comprises a first interface 52 in communication with other network nodes 70. The first interface 52 is able to detect if a target device 80 for the message is roaming. The first interface 52 is also able to detect if a deferring option is active for the target device 80 and to receive a notification indicating that the target device 80 is not roaming.

The network node 50 further comprises a database 54 for storing the message with the Ad component, when the first interface 52 detects that the target device is roaming and that the deferring option is active for the target device. The network node 50 further comprises a second interface 56 in communication with an Ad server 72, for retrieving a new Ad. The network node 50 comprises a processing module 58 for verifying if the Ad component stored in the database 54 is valid, for retrieving a new Ad using the second interface 56 and for updating the message with the new Ad if the Ad component stored with the message in the database 54 is not valid, when a notification indicating that the target device is not roaming is received by the first interface. The network node 50 further comprises a third interface 60, in communication with the target device 80, for sending the message with the Ad component to the target device 80.

Still referring to FIG. 2, according to another aspect of the invention, a network node 50 may receive a notification indicating that a second target device 82 is not roaming and is available or is requesting to receive the message. When the notification is received, the third interface 60, in communication with the second target device 82, may send the message with the Ad component to the second target device 82. As explained previously, in such a case, the Ad component of the message will likely be updated prior to sending, in order to adapt it better to the type of the second target device 82.

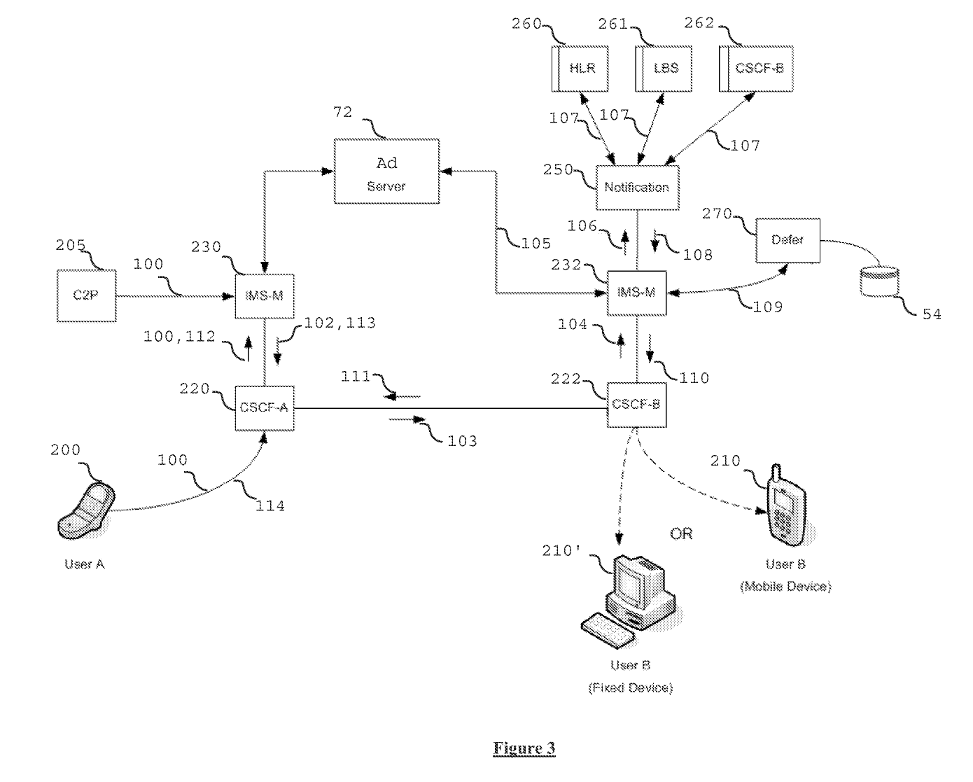

Reference is now being made to FIG. 3, which shows how the method of the invention may be executed by an exemplary embodiment of the invention implemented in an Internet Protocol (IP) Multimedia Subsystem (IMS) system. This example illustrates how an IMS user or a content server may send an IMS message to an IMS unregistered recipient i.e. a roaming or not currently available recipient. The message accompanied by an Ad component is deferred i.e. stored in a database, and when the recipient comes back online i.e. when an event package shows that he/she is available, the system attempts to send him the message with the Ad component. Before sending the message, however, some verifications are made. A verification regarding if the new Ad deferring feature is active may be made, a verification regarding if the Ad is still applicable, from a content or time-based perspective, may be made and if required a new Ad may be fetched from an Ad server. A verification regarding if the Ad is specific for a mobile, for a fixed device or for both types of devices may also be made. If the Ad is device specific, a further verification may be made regarding if the Ad applicable for to the recipients device which is now registered, as some Ads may be directed to fixed devices, while other Ads may be directed to mobile devices. According to the result of the verification, it may be necessary to fetch a new Ad.

FIG. 3 shows an example where a message is sent from User A 200 and is stored in a database 54 to defer the sending of the message to its recipient. At step 100, User A 200 or a Content Server 205 sends an IMS message to User B 210 or 210′ who is unregistered from the IMS network. i.e. roaming or unavailable. At steps 102 and 103, the IMS message is forwarded from the IMS Messaging Server (IMS-M) 230, which may fetch an Ad from the Ad server 72 and insert it into the message, to the terminating Call Session Control Function (CSCF) 222, through CSCF 220 for further analysis. At step 104, the IMS-M 232 on the terminating side receives the IMS message and performs internal verification to see if the recipient is online. If the recipient is registered, then the IMS-M 232 sends out the message to the recipient. However, in this example, User B's devices 210, 210′ are roaming or unavailable so the message is deferred.

At step 105, the IMS-M 232 issues a request to the Ad Server 72 to retrieve an Ad component to be inserted into the message, for example when a recipient is roaming or not currently available. The IMS-M 232 sends the request to the Notification function 250 at step 106 to verify if the recipient has the Ad deferring option. It has to be understood that the Notification function 250 may be implemented in software or hardware and that it can be collocated with another node of the network. If the recipient has the Ad deferring option, the Notification function 250 sets a “Notify Flag” to TRUE (this flag is set by default to FALSE). In addition, the Notification function 250 verifies if the IMS message was sent by a mobile device or by a fixed device and set the “Mobile Flag” accordingly (this flag is set by default to TRUE). In this example, the “Mobile Flag” is set to TRUE because the Notification function 250 is configured to use the type of device of the device used to send the message, to set the type of the recipient device, assuming that they are both of the same type. However, it should be noted that the system can be configured in many different ways and that a preferred type of device for the recipient could be used to set the “Mobile Flag” or the flag could also be set to a fixed value. As a person skilled in the art would readily understand this is totally configurable.

At step 107, in the case where an enabler has to be triggered for the notification service in order to tell IMS-M 232 that the user has just registered i.e., in the HLR case using the Alert-SC or in the LBS case using the Spatial Trigger, the Notification function 250 also sends a notify message out to the enabler 260, 261, 262. This step is not necessary in the IMS case since the CSCF 220 also receives the register event when the IMS user registers.

At step 108, the IMS-M 232 receives the Notification flag data from the Notification function 250. At step 109, the IMS-M 232 stores the message with the Ad component and the notification flag data that was set in step 6, in the database 54 through a Defer function 270. It has to be understood that the Defer function 270 may be implemented in software or hardware and that it can be collocated with another node of the network. At steps 110, 111, 112, 113 and 114, once the message is successfully stored, a “202 Accepted” message is sent back to the originating CSCF 220.

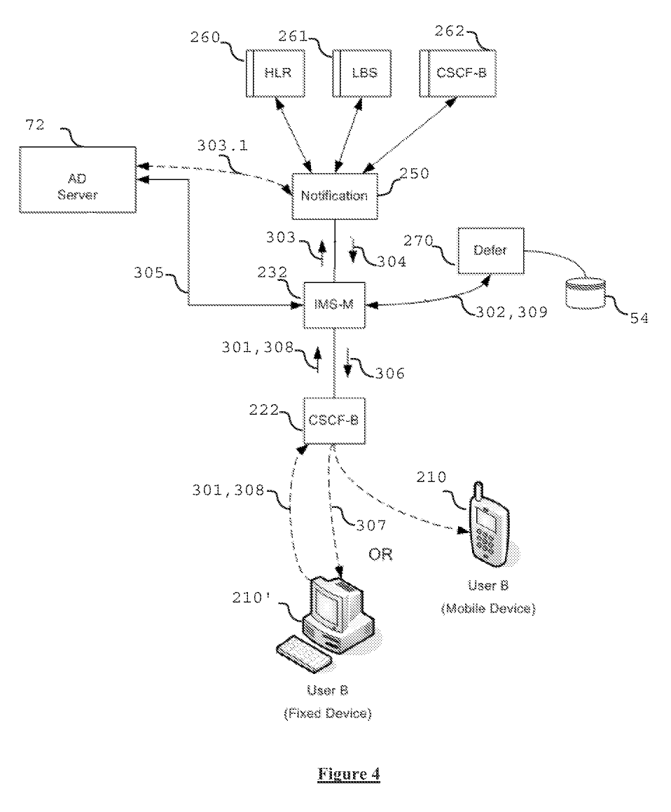

Reference is now being made to FIG. 4, which shows how the method of the invention may be executed by an exemplary embodiment of the invention implemented in an IMS system. This example illustrates how a deferred message may be send to its recipient when this one becomes available or stops roaming. At step 301, the recipient User B 210′ registers with his fixed device 210′ by sending a SIP SUBSCRIBE message. The CSCF 222 receives the SIP SUBSCRIBE messages (which contains the event package) and relays it to the IMS-M 232 at step 301. The IMS-M 232 knows that User B has registered and that it should proceed to check if the User B has the deferring function active. If so, the IMS-M 232 verifies if there are any messages waiting for User B 210′.

At step 303, the IMS-M 232 uses the new Notification function 250 to determine if the retrieved message(s) which also contain Ad component(s) need to be updated or not from an Ad component perspective. This means that the Notification function 250 verifies if the “Notify Flag” is set to TRUE and may also issue a request to the Ad server 72, at step 303.1, to verify the Ad validity. The step 303.1 is optional. Once this verification is done, the Notification function 250 also verifies the value of the “Mobile Flag”. In this example, the Ad component is still applicable from content and time perspectives, so no new Ad should be retrieved from the Ad server 72. However, the original message was stored and set for a mobile device 210 and not for a fixed device 210′. User B has now registered with his fixed device 210′. As a result, the Notification function 250 determines if a new Ad for the fixed device has to be retrieved. At step 304, the Notification function 250 returns a “Retrieve New Fixed AD” response to the IMS-M 232, including the recipient's URL and any other pertinent information.

At step 305 the IMS-M 232 receives the response from the Notification function 250 and immediately proceed to fetch a new Ad for User B 210′, from the Ad Server 72, which is specific to User B's fixed device 210′. It is assumed that the Ad Server 72 contains multiple versions of Ads and more specifically, different Ads for mobile and fixed devices.

Once the IMS-M 232 successfully receives the new Ad, it removes the old Ad from the message and replaces it with the new Ad. The message is then send to the CSCF 222. At step 306, the CSCF 222 receives the new message and forwards it to the User B fixed device 210′. At step 307, User B receives the new message with the Ad component. User B's fixed device 210′ then returns a 200 OK response at step 308. Once the IMS-M 232 receives positive acknowledgement of message reception, the IMS-M 232 removes the message from the database 54 via Defer function 270, at step 309.

The invention has been described with reference to particular embodiments. However, it will be readily apparent to those skilled in the art that it is possible to embody the invention in specific forms other than those of the embodiments described above. The described embodiments are merely illustrative and should not be considered restrictive in any way. The scope of the invention is given by the appended claims, rather than the preceding description, and all variations and equivalents that fall within the range of the claims are intended to be embraced therein.

1. A method, executed in a network node, for deferring a transmission of a message comprising an advertisement (Ad) component, comprising the steps of:
a) detecting that a target device for the message is roaming and that a deferring option is active for the target device;
b) storing the message with the Ad component;
c) after step b), receiving a notification indicating that the target device is not roaming; and
i) if the Ad component is valid, sending the message to the target device;
ii) else if the Ad component is not valid, retrieving a new Ad, updating the message with the new Ad and sending the message to the target device.

2. The method of claim 1, wherein the step i) further comprises: if a current date and time is within a time period where the Ad component is valid, sending the message to the target device.

3. The method of claim 1, wherein the step ii) further comprises: if a current date and time is outside a time period where the Ad component is valid, retrieving a new Ad, updating the message with the new Ad and sending the message to the target device.

4. The method of claim 1, further comprising, between steps b) and c), the step of sending a notification request to another network node, for receiving a notification indicating that the target device is not roaming.

5. A method, executed in a network node, for deferring a transmission of a message comprising an advertisement (Ad) component, comprising the steps of:
a) detecting that a first target device for the message is roaming and that a deferring option is active for the first target device;
b) storing the message with the Ad component;
c) after step b), receiving a notification indicating that a second target device is not roaming; and
i) if the Ad component is valid, sending the message to the second target device;
ii) else if the Ad component is not valid, retrieving a new Ad, updating the message with the new Ad and sending the message to the second target device.

6. The method of claim 5, wherein the step i) further comprises: if a current device type of the second target device corresponds to a device type for which the Ad component is valid, sending the message to the second target device.

7. The method of claim 5, wherein the step ii) further comprises: if a current device type of the second target device corresponds to a device type, for which the Ad component is not valid, retrieving a new Ad, updating the message with the new Ad and sending the message to the second target device.

8. The method of claim 5, further comprising, between steps b) and c), the step of setting a flag indicating a device type of the first target device and sending a notification request to another network node, for receiving a notification indicating that the second target device is not roaming.

9. The method of claim 8, wherein the step ii) further comprises: if a current device type of the second target device does not correspond to a device type indicated by the flag, retrieving a new Ad, updating the message with the new Ad and sending the message to the second target device.

10. A network node for deferring a transmission of a message comprising an advertisement (Ad) component, comprising:
a first interface in communication with other network nodes, said first interface detecting if a target device for the message is roaming, detecting if a deferring option is active for the target device and receiving a notification indicating that the target device is not roaming;
a database for storing the message with the Ad component, when the first interface detects that the target device is roaming and that the deferring option is active for the target device;
a second interface in communication with an Ad server, for retrieving a new Ad;
a processing module for verifying if the Ad component stored in the database is valid, for retrieving a new Ad using the second interface and for updating the message with the new Ad if the Ad component stored in the database is not valid, when a notification indicating that the target device is not roaming is received by the first interface;
a third interface, in communication with the target device, for sending the message with the Ad component to the target device.

11. The network node of claim 10, wherein the first interface further sends a notification request to another network node, for receiving a notification indicating that the target device is not roaming.

12. A network node for deferring a transmission of a message comprising an advertisement (Ad) component, comprising:
a first interface in communication with other network nodes, said first interface detecting if a first target device for the message is roaming, detecting if a deferring option is active for the first target device and receiving a notification indicating that a second target device is not roaming;
a database for storing the message with the Ad component, when the first interface detects that the first target device is roaming and that the deferring option is active for the first target device;
a second interface in communication with an Ad server, for retrieving a new Ad;
a processing module for verifying if the Ad component stored in the database is valid, for retrieving a new Ad using the second interface and for updating the message with the new Ad if the Ad component stored in the database is not valid, when a notification indicating that the second target device is not roaming is received by the first interface;
a third interface, in communication with the second target device, for sending the message with the Ad component to the second target device.

13. The network node of claim 12, wherein the first interface further sets a flag indicating a device type of the first target device and sends a notification request to another network node for receiving a notification indicating that the second target second device is not roaming.

14. The network node of claim 13, wherein the processing module retrieves a new Ad using the second interface, if a current device type of the second target device does not correspond to a device type indicated by the flag.
